(19) United States
(12) Patent Application Publication
(10) Pub. No.: US 2011/0122967 A1
(43) Pub. Date: May 26, 2011

(54) METHOD AND DEVICE FOR COMMUNICATION BETWEEN MULTIPLE WIRELESS UNITS

(75) Inventor: Per-Arne Wiberg, Halmstad (SE)

(73) Assignee: FREE2MOVE AB, Halmstad (SE)

(21) Appl. No.: 12/999,211

(22) PCT Filed: Jun. 15, 2009
(86) PCT No.: PCT/SE09/00302

§ 371 Date: Dec. 15, 2010

Related U.S. Application Data
(60) Provisional application No. 61/198,742, filed on Nov. 10, 2008.

(30) Foreign Application Priority Data
Jun. 16, 2008 (SE) 0801397-1

(51) Int. Cl. H04L 27/00

(52) U.S. Cl. 375/295

(57) ABSTRACT

A method and device for operating a wireless network comprising at least two user equipments, each comprising a transmitter and a receiver. A beacon frame is sent by a master user equipment at a transmit channel derivable from a user code. The beacon frame comprises a network code. Any user equipment may calculate a data channel by an algorithm using the user code and the network code. The user equipment may be an active user, which is permitted to send data over said data channel, or a passive user equipment, which only receives transmitted data at said data channel. Several active users may transmit simultaneously. Such active users are entered on a list at the beacon frame and is designated each a transmit channel. A passive user may become an active user, for example by pushing a button, whereupon the passive user is entered on the list of active user and at the same time takes over the task to send the beacon frame, i.e. becomes a master user.

### FIELD OF INVENTION

The present invention relates to a wireless system for exchange of information between multiple wireless units with minimum bandwidth requirement and minimum battery consumption.

### BACKGROUND OF THE INVENTION

A mobile telephone includes a transceiver. A Bluetooth unit comprises a transceiver. A laptop computer comprises a transceiver. Many electronic devices surrounding us comprise a transceiver.

There is a need for establishing wireless communication between users within a relatively limited geographical area.

Sometimes, there is a need for communication many-to-many users. Transceivers in Bluetooth units or mobile phones normally do not have communication many-to-many users but rather one user-to-basestation or master. For applications with many users the transmitting broadcast unit may not to be aware of the receiving units. Thus, a protocol for simple and efficient establishment of a MultiTalk communication is needed.

The present invention addresses such a need.

The document US 2008/0109880 A1 discloses a method utilized in a wireless local area network (WLAN) system. The WLAN system includes a station and an access point (AP). The method includes steps of: transmitting an input value to the station by the AP; utilizing the input value to calculate an initial service set identifier (SSID) and an initial key by the station; and utilizing the initial SSID and the initial key to perform an authentication procedure by the station and the AP.

The document WO 2005/006658A1 discloses a method for broadcasting beacon frames in a short-range wireless ad-hoc network including a plurality of wireless terminals. In order to improve the efficiency of the ad-hoc network in terms of power consumption, the terminal that defines the beacon interval for the network starts as a beacon broadcaster and introduces an identifier list in at least some of the beacon frames broadcast in the network. The identifier list, which includes identifiers of the wireless terminals belonging to the network, is utilized if another wireless terminal is to be selected as the beacon broadcaster.

### SUMMARY OF THE INVENTION

Accordingly, an object of the present invention is to mitigate, alleviate or eliminate one or more of the above-identified deficiencies and disadvantages singly or in any combination.

According to an aspect of the invention, there is provided a method of operating a wireless network comprising at least two user equipments, each comprising a transmitter and a receiver, the method comprising: sending a beacon frame by a master user equipment at a transmit channel derivable from a user code, said beacon frame comprising a network code; transmitting information data at a data channel obtained by an algorithm using said user code and said network code; receiving said beacon frame by another user equipment; extracting said network code from said beacon frame and calculating said data channel from said user code and said network code for receiving said transmitted information data.

According to an embodiment, the user equipments may be either a passive user equipment, which is able only to receive data, or an active user equipment, which as able to both transmit data and receive data. The passive user equipment may comprise a user code, which is specific for the network, which user code may be, for example, entered into the user equipment by a user or is hardcoded in the user equipment. The passive user equipment may be able to calculate the beacon frame channel based on said user code in order to receive the network code in the beacon frame, and may use the user code and the network code to calculate the data channel in order to receive the data. A passive user equipment may become an active user equipment by being designed a user identity, which may be entered on a list comprised in the master user equipment, said identity being connected to a data channel.

According to another embodiment, there may be several data channels for transmission of several information data streams substantially simultaneously from several active user equipments, wherein the data channels may be arranged in several time slots arranged in a time sequence after each other, and/or in several frequency channels arranged to be transmitted simultaneously. The transmission of information data may be performed by any active user equipment, including said master user equipment. The list of active users of said master equipment may be included in said beacon frame, and the list of active user may be limited to a specific maximum, such as maximum six simultaneous active users.

According to a further embodiment, when a passive user becomes an active user, the new active user may become master user and takes over the task to send the beacon frame.

According to a still further embodiment, the network may be an ad-hoc network. The network may be initiated when an initiating user wants to send information, whereupon a beacon frame may be sent followed by transmission of data information, and wherein the network may be terminated when there is no active user except the master user and the master user terminates sending the beacon frame.

According to a yet further embodiment, the receiver and transmitter may be comprised at a custom made integrated circuit or a Bluetooth circuit. The receiver and transmitter may be included in a WLAN device, wherein a Physical Layer of the WLAN device is connected to a MultiTalk Protocol Layer, either directly or via an IP block and a UDP block.

According to another aspect, there is provided a device for performing the method mentioned above, which device may comprise a transmitter and a receiver and a control unit for performing the method steps indicated above.

According to a further aspect, there is provided software arranged on a tangible medium for controlling the control unit mentioned above.

### BRIEF DESCRIPTION OF THE DRAWINGS

Further objects, features and advantages of the invention will become apparent from the following detailed description of embodiments of the invention with reference to the drawings, in which:

FIG. 1 is a schematic diagram showing seven user equipments.

FIG. 2 is a block diagram showing implementation of the embodiments.

FIG. 3 is a schematic diagram of a superframe.

### DETAILED DESCRIPTION OF EMBODIMENTS

Below, several embodiments of the invention will be described with references to the drawings. These embodiments are described in illustrating purpose in order to enable a skilled person to carry out the invention and to disclose the best mode. However, such embodiments do not limit the invention. Moreover, other combinations of the different features are possible within the scope of the invention.

If a user requires exchange of information, the user may want to use a network for transmission of such information. If there is no network available, the user may want to initiate a network according to the embodiments described below.

The first user may set up a wireless network by sending a specific beacon frame at a specific channel frequency, as further described below. This may be regarded as the birth of the wireless network. Thus, the network is set up temporarily at need and may be called an ad-hoc network.

The network is a closed network, meaning that a user needs to know a code in order to join the network and decode the information. A second user connects to the network by means of a user code. The code is so constructed that the specific beacon frame channel can be identified from the code. Thus, by using the code, the second user calculates the specific beacon frame channel and can receive the beacon frame at said channel.

The beacon frame comprises a network code, for example a time stamp or a clock. The information channel, over which the information is sent, is calculated from the user code and the network code. Then, the second user receives the information from the first user at said information channel.

Any user that happens to listen at a specific channel may receive the beacon frame and understand that a network has been formed. However, without knowing the user code, such a sporadic listener cannot calculate the information channel at which the actual information is sent, since the calculation of said information channel is done by using the user code in combination with the network code received in the beacon frame.

A third, fourth etc user may join the network by means of the user code and receiving the beacon frame including the network code and calculating the information channel and receiving the information.

Such information may be directed in a single direction, i.e. the first user sends information that is received by all other users. Such a situation may exist for example in a museum, in which a first user is the guide that talks to a group of listeners.

The first user is the initial master of the network and is required to send said beacon frame regularly. This puts a high demand on the first user, since sending of the beacon frame consumes power. Thus, the master user may consume more battery power than the non-master users. It is noted that the present network is not a master-slave network. The word “master” is only used for indicating a user, which performs the task of sending the beacon frame or corresponding information, which is required to support the network being set up.

The network comprises a function according to which the master function, i.e. the task to send the beacon frame may be distributed among the active users.

This may take place in several manners. The initiator of the network is always the first master user. However, when a second user joins the network, the second user may become the master user. However, since it is not easy to know that a user that only listens to the network has joined the network, the network comprises a function according to which a user may be passive and only listen to the network, i.e. a simplex user, and a function according to which a user may become active and sending information over the network, i.e. a duplex user.

In order to arrange for the distribution of the task to send the beacon frame, any user that becomes active takes over the master function, i.e. the task to send the beacon frame. In this way, the last user to become an active user is the master user. Thus, the master function is distributed among the active users, i.e. the duplex users. There may be other manners to distribute the task to send the beacon frame, see further below.

Moreover, if the first user becomes inactive, he will not drain his battery any longer, since the master function is taken over by the next active user, and since a passive user will only listen to the communication, which drains much less power than transmitting. In fact, a first user may initiate a network and participate for some time in the network, and then withdraw, while the network continues to live for several days or weeks with new master users. Thus, once started, the network may be said to have its own life.

The network is terminated when there is no further need for the network. One way to terminate the network is to define that if no information is sent over the network during a specific time period, such as 1 minute, the network terminates automatically, and no further beacon frame is sent. Thus, the master has the task to overview the traffic and if no traffic is present for a predetermined period, the master terminates to send the beacon frame, which in effect terminates the network, and the network becomes dead.

There may also be a function according to which a non-master, active user may withdraw and become a passive user or simply leave the network. If a master user withdraws, it may be regarded as the same as terminating the network, see further below.

When the network has been terminated, a new network has to be set up as described above, if further information is to be sent.

Any user, which becomes an active user, receives an identity. Thus, the identity of a user is dynamic. The identity of a new active user may be the actual time stamp when the new user becomes active. When an active user becomes passive, the user looses his identity and obtains a new identity the next time the same user becomes active. The identity is used for designating a specific data transmission channel.

The beacon frame is sent over a frequency, which may be calculated from the user code. The user code may be a pin code comprising two, three or four etc digits.

One way of calculating the beacon frame frequency or channel may be that the frequency of the beacon frame may be the frequency of a channel, which is the sum of the four digits. For example, if the code is 1649, the frequency corresponds to channel 20, for example at the free frequency band of 2.4 GHz used by such systems, which frequency band for example comprises 100 channels separated by 1 MHz.

Another manner to determine or calculate the beacon frame frequency channel may be to take the last two digits in the user code. If the user code is only two digits, the channel becomes the user code.

The data information may be sent according to a frequency hop algorithm using the user code and the time stamp of the beacon frame for calculating the information channel. One such algorithm may be calculated in the following manner. The user code may be a pin CODE as indicated above, and is fixed for the network. The network code may be dynamic and may be a time stamp or CLOCK included in the beacon frame. The time stamp may be set at the initiation of the network to any desired value, for example to 00. Then, the time stamp is incremented by one for each time a beacon frame is sent and is wrapped over to zero at overflow.

One algorithm for calculating the channels for the transmission of the data information may be the following:

The CLOCK and the user CODE are merged together with a bitwise OR or XOR function to create a CLOCKCODE value. The CLOCKCODE value is fed into a random function as a seed. The channels of a hopping sequence within a superframe is generated by calling this random function 6 times, one time for each channel in the superframe. This procedure is repeated every superframe with a new CLOCKCODE value, since the CLOCK is incremented each new superframe.

In this way, it is required to know both the user code and the network code (CODE and CLOCK) as well as the algorithm in order to calculate the data channel. Another algorithm may alternatively be used, such as Chdata=the last two digits of (CODE*CLOCK).

A network, according to an embodiment, may be used for serving up to six duplex users. Two channels may be used for sending information in three time slots, which is explained in more detail below. Thus, a first duplex user may send at a first channel in a first time slot, and a second duplex user may send at a second channel in the first time slot. A third duplex user may send at the first channel in a second time slot, and a fourth duplex user may send at the second channel in the second time slot. A fifth duplex user may send at the first channel in a third time slot, and a sixth duplex user may send at the second channel in the third time slot.

All six transmissions may be received by any and all users, active or passive.

Thus, in a superframe, there is sent a beacon frame and three data frames. In addition, the superframe comprises a second frame, called beacon response frame, and three additional data frames. The use of the different frames in the superframe is explained in more detail below.

If there are only four duplex users that are sending information, the third time slot may become idle in order to save battery. If there are only two duplex users, also the second time slot may become idle.

According to an embodiment, when a user becomes active, he takes over the master function to send the beacon frame. The new duplex user takes the current time stamp as his identity stamp. The previous master, who has an earlier time stamp, is shifted one step down on the list of active users, while keeping his time stamp. The list may comprise six active users. When a seventh user requests to be added on the list, the oldest active user is pushed out of the list and the seventh user becomes the new master. Other manners of handling the list of active users are indicated below.

The list of active users is included in the beacon frame. Thus, if a previous user, that has first become master and then has been pushed down the list of active users, for example to position five, wants to transmit information again, he will not take over the function as master, but simply transmit information again under his previous identity (i.e. the time stamp when becoming a master). However, if the same user a few moments later has been pushed out of the list and wants again to send information, he has to request to become active, take over the master function and obtain a new identity, and then transmit information.

Thus, each unit obtains an identity only at the moment he becomes master and keeps this identity until he is pushed out of the list. Thus, the identity of the active user is dynamic.

By arranging that the latest unit that wants to transmit information to become the master, the extra battery drain caused by the master function and the task to send the beacon frame is distributed to the units that want to be active and sending. All other passive users that only listen or transmit rarely, draw very much lower battery power.

The identity is used for assigning a data transmission channel to the active user. Thus, the user identity may be connected to one of the six possible transmission channels when the user identity is defined, i.e. when the user becomes an active user. Thus, the user maintains the same transmission channel until the user is removed from the list of active users.

Another alternative is that each position at the list of active users is assigned to a specific transmission channel. Thus, Tx1 may be assigned to the first channel in the first time slot (i.e. the first transmission channel), Tx2 may be assigned to the second channel in the first time slot (i.e. the second transmission channel), Tx3 may be assigned to the first channel in the second time slot (i.e. the third transmission channel), etc. Thus, each user shifts the transmission channel in dependence on the position at the list.

It is noted that the number of transmission channels may be different from six, such as three channels in three time slots, two channels in two time slots, two channels in one time slot at two different frequency channels, four transmission channels in two frequency channels and two time slots etc. The frequency channels may be sent at the same frequency during a superframe or at different frequencies as indicated below.

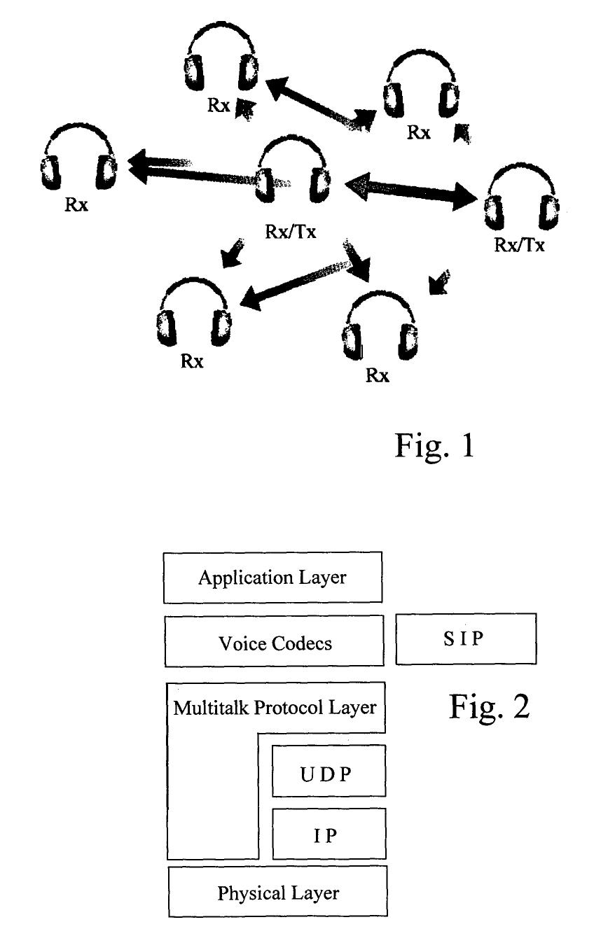

A system for providing communication as described above is shown in FIG. 1. The system comprises several users shown as headsets comprising Bluetooth communication units. Seven users are shown in FIG. 1. Two of the users in FIG. 1 are designated with Rx/Tx, which means that these two users have the ability to both receive (Rx) and transmit (Tx) information, i.e. are active users. The other users indicated with Rx only have the ability to receive information, i.e. are passive users.

The units communicate directly with each other via a wireless system, such as Bluetooth or any other radio communication method. The communication may as well be another type of wireless communication, such as via infrared radiation (IR) or ultrasound.

The system is a multi-talk system implicating that several of the users may be active, for example talk at the same time. However, there may be a restriction as to how many users that are active and are able to talk at the same time, i.e. how many duplex communication paths that may exist simultaneously, for example due to bandwidth restrictions. There is no restriction on the number of passive users that only listens.

In one embodiment described in all details below, a maximum of six active, duplex users may exist at the same time. However, the total number of users, i.e. passive and active users, may be several hundreds or more (unlimited).

The system is a closed system, meaning that all users must employ a user code in order to join the system. Such a code may be a pin code, for example comprising four digits.

All users are initially passive users. A user becomes a passive user simply by entering the user code into the device, for example by means of a keyboard. Alternatively, the user code may be embedded in the device beforehand, for example at the time of manufacturing, or be stored in a memory, that may be altered by the user at any time. Then, a user becomes a passive user at the initiation of the device, that is always when the device is on. The device always scans the frequency spectrum after a beacon frame at the expected channel frequency determined by the user code.

If a passive user would like to become an active user, the passive user sends a signal to the system or network. Then, the requesting passive user becomes an active user.

The system is suitable for voice communication, but the system may include any type of data to be transferred between two or several users.

The system may be combined with other devices such as a radio controller and receiver (for receiving FM radio transmissions), a Bluetooth transceiver, a WLAN transceiver (according to IEEE 802.11a, b, g, n) and a specific MultiTalk transceiver.

The Bluetooth transceiver may be arranged to run the lower part of the Bluetooth stack (HCI), while the upper part of the stack may run in the MultiTalk controller. The main profiles that are supported may be: SPP, HFP, A2DP.

However, the MultiTalk functionality can be included in the WLAN transceiver and/or the Bluetooth transceiver as an overlay protocol in a Protocol Layer interacting with a Physical Layer.

The system uses a minimal bandwidth and a minimum of battery power. Many users intended for the system are battery operated, and thus low power consumption is at premium.

A first embodiment for a multi-talk system is described below. It includes up to six duplex users and an unlimited number of simplex users. For the transmission of data, the system uses two channels of a communication system, for example two transmit frequencies at the same time, separated by 8 MHz

The system uses a structure, which comprises a beacon frame followed by three data frames. Then, there is a beacon response frame followed by three data frames. Each frame comprises up to 32 bytes. The cycle time for these 8 frames is 4 ms.

The frames are transmitted using radio wave communication at the free frequency band of for example 2.4 GHz used by the Bluetooth system. There may be 100 channels separated by 1 MHz.

The system may be set up by any user equipment, below called UE, which comprises a transceiver for reception and transmission of a radio frequency signal in the intended frequency band. Moreover, the UE comprises keys for operation of the UE, for example twelve keys corresponding to the digits from “0” to “9” and * and #.

The system uses a base frequency, which is calculated, based on the pin code. The first UE dials a pin code on the keys, for example 1620. Then, the base frequency becomes the last two digits of the pin code, i.e. channel 20.

The UE is tuned to channel 20 and listens to any traffic at said channel. If the UE receives a signal, it decodes the signal and looks for a beacon frame transmitted by another UE.

If no beacon frame is received within a first time interval, for example 50 ms, there is deemed to be no multi-talk network in the system at the channel corresponding to the relevant pin code. Then, the UE will set up a network, according to the following:

The UE generates a beacon frame comprising, for example, the information according to the table 1 below.

| FIELD | Size | Description |
|---|---|---|
| CLOCK | 2 bytes | This is an unsigned 16 bit field incremented every sent |
| | | beacon. The CLOCK wrap back to 0 when overflowed |
| CONFIGURATION | 1 byte | Bitfield to represent the global network settings (e.g. |
| | | push-to-talk enabled), as described below |
| SUPPORTED_SERVICES | 2 bytes | Reserved for future use |
| TX1_HANDOVER | 2 bytes | Acknowledge of timestamp for the new TX1 node |
| CHECKSUM | 2 bytes | XOR checksum of beacon packet to detect corruptness |
| TX_POOL_SIZE | 1 byte | The maximum number of TX nodes allowed in the |
| | | MT network, 6 nodes are supported in this example |
| TX1_CLKSTAMP | 2 bytes | The timestamp when a specific node became TX1 |
| — | — | — |
| TX6_CLKSTAMP | 2 bytes | The timestamp when a specific node became TX6 |

The clock, also called time stamp, is initiated to a desired value, for example 00, or a specific value, such as 63. The other bits are set to zero, or any other value desired.

Then, the beacon frame is transmitted by the UE at the beacon frame channel previously calculated. Now, a network is established.

Any UE, which dials the pin code 1620, may now join the network and listen to any communication from the master UE called TX1.

If another UE, which has already joined the network by dialing the pin code, wants to become an active user, the # key is pressed in order to initiate a sequence for becoming an active user. First, the requesting UE, below called reqUE, listens for a beacon frame during 5 ms at the frequency band selected by the pin code previously dialed, in order to ensure that at least one beacon frame is received, if any beacon frame is transmitted. Since a network has been established as indicated above, a beacon frame is received.

Now, the new user, reqUE, indicates that he wants to take over as master and wants to send information by sending a beacon response frame at the time slot reserved for such a beacon response frame. The channel over which the beacon response frame is transmitted may be the same as the beacon frame channel, or another channel calculated by an algorithm based on the user code and/or the network code. The reqUE now stores the current clock-value as its own identifier.

The present master user receives the beacon response frame and takes that as an indication that he should not transmit a beacon frame at the next occasion.

The new active user, reqUE, to become a master user, now transmits a beacon frame at the next occasion indicating himself as the master (Tx1) and the previous master as the next active non-master user (Tx2). All previous other active users (Tx2 to Tx5) are moved down one step on the list and the active user Tx6 which has been entered first to the list is moved out from the list and becomes a passive user.

The previous master user also receives the new beacon frame and takes that as an acknowledgement that he no longer has the task to send the beacon frame.

A beacon response frame may include 8 byte and have the format according to the table 2 below:

| FIELD | Size | Description |
|---|---|---|
| SUPPORTED_SERVICES | 2 bytes | Reserved for future use |
| ACTIVATE_CLKSTAMP | 2 bytes | The timestamp of a node that would like to become |
| | | active and take the role as Tx1 in the network |
| DEACTIVATE_CLKSTAMP | 2 bytes | The timestamp of a node that would like to become |
| | | passive and be removed from the Tx list |
| CHECKSUM | 2 bytes | XOR checksum of beacon packet to detect |
| | | corruptness |

Both the beacon frame and the beacon response frame may be sent on two channels simultaneously or in sequence, in order to make sure that the beacon frame and beacon response frame are received without corruptness.

An active user may want to request to become a passive user. This may take place in a manner similar to becoming an active user.

If a user, for example Tx3, which is not a master user wants to become a passive user, the * key is pressed, whereupon the reqUE sends a beacon response frame in the time slot reserved for the beacon response frame. The beacon response frame comprises the timestamp of the Tx3 in the DEACTIVATE_CLKSTAMP position. The current master user receives the beacon response frame and notes that there is a timestamp, which is non-zero in the DEACTIVATE_CLKSTAMP position. Then, the master user looks if the received timestamp corresponds to any timestamp stored at the list of active users, for example Tx3. Then, the timestamp of Tx3 is removed and the later active users Tx4 to Tx6 are moved up one step to fill the list.

If the current master user wants to be removed from the list, the following sequence is followed. As indicated above, the * key is pressed. The master user Tx1 then checks if there are any other active users on the list, for example Tx2. If there is no active user on the list, the master user terminates the network by ceasing sending the beacon frame.

If there is another active user on the list, the master user sends a beacon response frame, in which the DEACTIVATE_CLKSTAMP position includes the timestamp of the master user. Then, the master user sends a new beacon frame in the time slot reserved therefore.

The last added non-master user, Tx2, notes that he is asked to take over the position as master by receiving the beacon response frame. He waits until he has received the next beacon frame, which is still transmitted by the previous master user. Then, Tx2 sends a beacon response frame in which he inserts his own timestamp in the ACTIVATE_CLKSTAMP position, thereby requesting to become the master user. The previous master receives this beacon response frame and takes this as an acknowledgment that he is no longer master. Now, the previous master has become an active non-master user, and sends a new request to be deactivated by sending his timestamp in the DEACTIVATE_CLKSTAMP position a second time. Now, he is removed from the list as indicated above for a non-master, active user.

It may happen that a master user fails of one or the other reason, such as battery failure. In order to cope with such as situation, all active users always listen for the beacon frame. If the beacon frame is missing for a number of times, for example after 5 consecutive missed beacon frames, the user which is currently Tx2 will automatically take over the position as Tx1 after another 2 missed beacon frames. If Tx2 does not take over after another 2 missed beacon frames, i.e. totally 7 missed beacon frames, Tx3 will take over after another 2 missed beacon frames, etc.

The network presumes that all users are within radio reach from each other. This may not always be the case. If a passive user is out of reach, the network does not care, it is up to the passive user to move himself into reach of the master user and the transmitting active user. If an active non-transmitting user comes out of reach from the master user and the transmitting users, again, the network does not care. However, if a transmitting user comes out of reach of a master user, problems may arise, since the transmitting user may not receive the beacon frame. Moreover, the master user does not receive the data information. In this case, no useful information can be transmitted. This situation is dealt with in the following manner. The master user listens at the data channel and determines that a specific active user is transmitting. Then, if the transmitting user is not Tx2, but for example Tx5, the transmitting user is moved up to position Tx2, and the remaining active users are shifted down one step. This rearrangement results in that an active user, which does not transmit, is shifted down the list. When a further user wants to become active, the least active user is shifted out from the list. Thus, if an active user wants to transmit data, but is out of reach from the master user, he will still be moved down the list until he is removed from the list.

The active area of the network may be enlarged by using one or several repeaters that retransmit the data stream.

The master user has the task to send the beacon frame. The task to be a master user may be shifted between the active users in other manners than indicated above. One example is that every active user on the list has the task to send the beacon frame in order, so that Tx1 sends the beacon frame in a first superframe, Tx2 sends the beacon frame in a second superframe, Tx3 sends the beacon frame in a third superframe, etc, until Tx1 again sends the beacon frame in a seventh superframe, etc. If there are less than six active uses, the master function is distributed among them. Instead of shifting the master function each superframe, each active user may support the master function for a number of superframes, such as 8 superframes, whereupon the master function is shifted to the next active user, etc.

The transmissions may take place in many different ways. An exemplary protocol is described below.

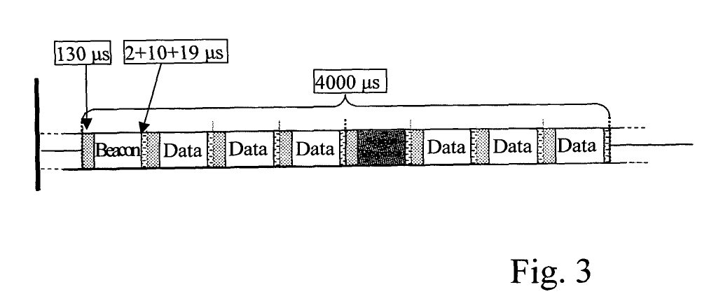

The transmissions take place in a superframe having the structure shown in FIG. 3. The superframe has a duration of 4000 μs and comprises one beacon frame, three data frames, one beacon response frame and another three data frames. The entire superframe is not transmitted on a single channel, but several channels are used. Each frame is a burst of maximum 32 bytes occupying a time of 481 μs. The beacon frame starts with a wakeup time space of 130 μs followed by beacon data during 339 μs. Each data frame starts with a time space of 31 μs for accommodating skew and standby times followed by information data during 469 μs. Each data packet comprises 32 bytes and a header and a checksum.

The three data frames after the beacon response frame may be used for transmission of the same data as in the first three data frames following the beacon frame. In this way, all data are sent twice, which means that the likelihood that they should be well received is increased. By using different channels for sending the data in the first data frames as in the second data frames, any interference influencing upon a part of the frequency band of the transmission channels may be circumvented. Thus, the second data frames should be sent over data channels being remote from the data channels used for the first data frames. The random function generator may include software for such situations.

One example of channels selected for a complete superframe may be as follows: The beacon frame and beacon response frame are sent on a channel calculated based on the pin code. If the pin code is 1620, the channel is 20. Different pin codes may result in the same channel, but the system may be organized so that only 99 pin codes are used. The data channels in the first time slot may be calculated according to the above-mentioned algorithm.

The above-mentioned protocol includes that a beacon frame is sent each 4000 μs. Other protocols may be used, for example a protocol in which first a beacon frame is sent. The beacon frame is 481 μs. Then, a beacon response frame is sent by all active users in sequence starting with the master user followed by Tx1, Tx2 etc, i.e. all active users on the list. Each beacon response frame is 10 bytes and includes in addition to the fields indicated in Table 2 also 2 bytes indicating the length of the following transmission of data bytes, for example 74H (which is 116 decimal) indicating that 116 data bytes will follow in a transmission from Tx1, etc. After sending the beacon frames, a number of beacon response frames and all data information bytes, a new beacon frame followed by beacon response frames is sent.

Since the beacon frame channel is calculated from the pin code, the network is sensitive to disturbances on the beacon frame channel. Thus, each beacon frame can be sent over two channels differing by more than 20 channels. The bacon frames can be sent in sequence or simultaneously over said two channels.

Another method is that before initiating a network, the initiating user may evaluate the channel calculated by the pin code. If the channel calculated by the pin code is disturbed, an alternative channel being remote from the first channel may be used. When a new user wants to join a specific network defined by the pin code, the user should listen at the first channel, and if no beacon frame is found on that channel, shift to the alternative channel and listen at the alternative channel, before determining that no network is present. Then, a new network may be initiated.

A new user takes part of the network by dialing a pin code and using the pin code for calculating the beacon frame channel. However, any user equipment may have the pin code preprogrammed so that no dialing is required, for example included in a memory. A user equipment may have several pin codes stored for participating in several networks. Any means for selecting pin code can be used, such as active selection by a user pressing a toggle switch or any other means. The pin code can also be selected based on automatic data, such as a GPS signal indicating that the user equipment is situated at a specific geographic position.

As indicated above, pressing the # key indicated that a user equipment wanted to become an active user of the network, i.e. push-to-talk. However, such pressing of a key can be replaced by an automatic activation, when a user talks into a microphone. The presence of a microphone signal of a specific magnitude may be an indication that the user equipment wants to transmit data, i.e. speak, and a request to join the network defined by the preprogrammed pin code is emitted. In the same manner, the absence of a microphone signal for a time period may indicate that the user equipment wants to become a passive user. Such a time period may be relatively long such as 10 seconds or several minutes.

The network according to the above embodiments may be used in many applications.

One application is for communication between an airport personnel and airplane pilots in the neighborhood.

Another application is in a museum, in which the master user may be the guide and the passive users the participants in the guided group. When a participant wants to ask a question, he presses a button to indicate that he wants to talk. When he is ready, he releases the button, which indicates to the system that he wants to become a passive user again.

A further application is when sharing data, such as MP3 music files or video films. A first user initiates the network and sends his data whereupon the passive receivers become active and confirms the receipt or request retransmission of part of the data. The receiver may also return another MP3 file to the first user.

A yet further application is in an office environment as an automatic intercom system.

A user equipment UE suitable for being used in the above-mentioned system is an equipment having the capacity to receive at a specific channel and to either receive or transmit at another channel separated from the first channel by for example 8 MHz. In a passive mode, such a passive user equipment may receive two channels simultaneously in the first time slot, followed by another two channels in the second time slot and followed by another two channels in the third time slot. Thus, the UE receives six channels substantially simultaneously and such six channels may be mixed to a single data stream, which is presented to the user, such as six voices. All such six voices may talk at the same time. In an active mode, the UE is able to send in one of the six possible channels, while at the same time receiving in the other five channels. Such five channels are mixed to a single data stream, which is presented to the user.

The data streams may be compressed in a manner known per se. Thus, if the data is voice data, a microphone signal may be sampled at a sampling rate of for example 8000 samples per second or any other sampling rate, such as 44.1 KHz. The sampling may have a resolution of for example 8 bits, or any other resolution, such as 16 bits or 24 bits. Thus, a bitstream having a bitrate of the sampling rate*the resolution is obtained. This bitstream may be compressed using any known compression method (codec) such as MP3 or a Speex coder/decoder performed by a Kalimba DSP (Digital Signal Processor).

A user equipment may be arranged to select one or a few of the data streams for presentation to the user. Thus, the UE may select the second data stream and/or the third data stream, etc and present only these data streams to the user. Such selection may take place by means of the keyboard.

A user equipment UE can be a mobile telephone having a transmitter and receiver. Alternatively, the UE can be a Bluetooth unit having a transmitter. The user can alternatively be a gateway, which connects the network with another structure. Thus, a gateway can be a receiver, which is connected to Internet, so that the network can be listened to via Internet. Similarly, a gateway may be an active user, so that information may be exchanged via the ad-hoc network and via the gateway to the Internet.

A user may be a device, which is not directly controlled by a user, such as a control node in a surveillance network, such as a theft intrusion system. In such a theft intrusion system, one or several sensors are connected to an intelligent node. Such sensors may be IR-sensors, which monitor a geographic area as to the presence of persons within the area. It a person enters the area, the IR-sensor emits a signal to the intelligent node, which initiates the node as a user in a network as described above. The node sends a beacon response frame and requests to become an active user, whereupon it sends the data obtained by the IR-sensor to a central user, which may be arranged in a monitor station of the theft intrusion system. After sending the data, the node requests to become a passive user by generating a beacon response frame as indicated above. After becoming a passive user, the node may be disconnected until receipt of the next signal from the IR-sensor. The previous master user, such as the above central user, now becomes the master user again.

By using beacon frame channels and data channels, which are distributed over a specific frequency band, such as channels 0 to 99 of a 2.4 GHz frequency band, several ad-hoc networks may coexist simultaneously.

It is noted that the network uses a beacon frame as carrier of information about the network. However, any other type of information carrier about the network, which is equivalent with a beacon frame, can be used as information carrier.

It is noted that the network code is changing with time, such as incremented by one for each superframe cycle. However, the network code may be changed in another pattern, for example incremented by 13 and decremented by 7 and then again incremented by 13 etc. The network code can also be static, i.e. the same as in the previous superframe.

It is noted that the user code is static, i.e. predetermined. However, the user code may change with time, for example comprising the month and day number, such as 0612 for June 12. The user code may change in another pattern known to the user.

It is noted that the user code is static, but the algorithm may as well be dynamic, for example including multiplication of the seed, before using the seed, by a figure corresponding to the day of the week, such as “1” for Sunday, “2” for Monday etc.

In the embodiments described above, a wireless transmission system comprising up to 100 channels has been included. In this case, the wireless transmission system may be embodied as a custom made integrated circuit.

Alternatively, the transceiver system of a current device can be used, such as a Bluetooth device or a WLAN device, which comprises a “Physical Layer” as shown in FIG. 2. The “Multitalk Protocol Layer” can be directly integrated and connected to the Physical Layer, as shown to the left in FIG. 2. Alternatively, as shown to the right in FIG. 2, the Multitalk Protocol Layer can be connected to the Physical Layer via an “IP” (Internet Protocol) block and a “UDP” (User Datagram Protocol) block, in which case Voice over IP can be transmitted via the Multitalk Protocol Layer.

The Multitalk Protocol Layer is connected to Voice Codecs and to an Application Layer. The Voice Codex may code the five or six incoming data streams and the one outgoing data stream from each application, which may be a head-set including a microphone and earphones. As mentioned above, the Application Layer may comprise other devices as is well known in the art.

As shown in FIG. 2, the Voice Codecs may be connected to a “SIP” (Session Imitation Protocol) block for receiving/transmitting VoIP signals.

When using a WLAN system for the transmission, there may be as few as three channels for transmission. However, it is sufficient to have three channels.

Instead of using channels separated in the frequency domain, channels separated in the time domain may be used.

The systems according to the above-described embodiments cannot be used without the knowledge of the User Code, which means that the system can be used for obtaining data only after payment of a subscription fee, whereupon a User Code is obtained. The data stream may be further coded by other encryption methods, for example by using a longer User Code, whereupon a portion of the User Code is used as a channel selector and another portion (or the entire User Code) is used for encryption purposes. In addition, the Network Code may be required for decrypting the data, possibly in combination with the User Code.

Although the present invention has been described above with reference to specific embodiment, it is not intended to be limited to the specific form set forth herein. Rather, the invention is limited only by the accompanying claims and other embodiments than the specific above are equally possible within the scope of these appended claims.

In the claims, the term “comprises/comprising” does not exclude the presence of other elements or steps. Furthermore, although individually listed, a plurality of means, elements or method steps may be implemented by e.g. a single unit or processor. Additionally, although individual features may be included in different claims, these may possibly advantageously be combined, and the inclusion in different claims does not imply that a combination of features is not feasible and/or advantageous. In addition, singular references do not exclude a plurality. The terms “a”, “an”, “first”, “second” etc do not preclude a plurality. Reference signs in the claims are provided merely as a clarifying example and shall not be construed as limiting the scope of the claims in any way.

1. A method of operating a wireless network comprising at least two user equipments, each comprising a transmitter and a receiver, the method comprising:
sending a beacon frame by a master user equipment at a transmit channel derivable from a user code, said beacon frame comprising a network code;
transmitting information data at a data channel obtained by an algorithm using said user code and said network code;
receiving said beacon frame by another user equipment;
extracting said network code from said beacon frame and calculating said data channel from said user code and said network code for receiving said transmitted information data.

2. The method as claimed in claim 1, wherein each of said user equipments is either
a passive user equipment which is able only to receive data, or
an active user equipment, which as able to both transmit data and receive data, wherein
a passive user equipment comprises a user code, which is specific for the network, which user code is for example entered into the user equipment by a user or is hardcoded in the user equipment, whereby the passive user equipment is able to calculate the beacon frame channel in order to receive the network code in the beacon frame, and use the user code and the network code to calculate the data channel in order to receive the data; and wherein
a passive user equipment becomes an active user equipment by being designed a user identity, which is entered on a list comprised in the master user equipment, said identity being connected to a data channel.

3. The method as claimed in claim 2, further comprising several data channels for transmission of several information data streams substantially simultaneously from several active user equipments, wherein the data channels are arranged in several time slots arranged in a time sequence after each other, and/or in several frequency channels arranged to be transmitted simultaneously.

4. The method as claimed in claim 1, wherein said transmission of information data is performed by any active user equipment, including said master user equipment.

5. The method as claimed in claim 2, wherein said list of active users of said master equipment is included in said beacon frame, and wherein the list of active user is limited to a specific maximum, such as maximum six simultaneous active users.

6. The method as claimed in claim 2, wherein when a passive user becomes an active user, the new active user becomes master user and takes over the task to send the beacon frame.

7. The method as claimed in claim 1, wherein said network is an ad-hoc network.

8. The method as claimed in claim 7, wherein the network is initiated when an initiating user wants to send information, whereupon a beacon frame is sent followed by transmission of data information, and wherein the network is terminated when there is no active user except the master user and the master user terminates sending the beacon frame.

9. The method as claimed in claim 1, wherein said receiver and transmitter are comprised at a custom made integrated circuit, or is comprised in a Bluetooth circuit.

10. The method as claimed in claim 1, wherein said receiver and transmitter are comprised in a WLAN device, wherein a Physical Layer of the WLAN device is connected to a Multitalk Protocol Layer, either directly or via an IP block and a UDP block.

11. A device for performing the method according to claim 1, which device comprises a transmitter and a receiver and a control unit for performing the method steps of at least one of the previous claims.

12. Software arranged on a tangible medium for controlling the control unit according to claim 11.
